(19) United States
(12) Patent Application Publication
(10) Pub. No.: US 2023/0174823 A1
(43) Pub. Date: Jun. 8, 2023

(54) LOW REFLECTANCE DUAL CURE ADHESIVE COMPOSITIONS

(71) Applicant: Henkel AG & Co. KGaA, Duesseldorf (DE)

(72) Inventors: Puwei Liu, Glastonbury, CT (US); Robert P. Cross, Rocky Hill, CT (US); Jiangbo Ouyang, Wallingford, CT (US)

(21) Appl. No.: 18/106,176

(22) Filed: Feb. 6, 2023

Related U.S. Application Data
(63) Continuation of application No. PCT/US2021/071110, filed on Aug. 5, 2021.
(60) Provisional application No. 63/061,389, filed on Aug. 5, 2020.

(51) Int. Cl. C09J 5/06; C09J 11/04

(52) U.S. Cl. CPC C09J 5/06; C09J 11/04; C09J 2301/416; C09J 2301/312; C09J 2301/408

(57) ABSTRACT

A dual-cure adhesive composition that exhibits very low visible light reflectance when in a cured condition. The adhesive is curable by electromagnetic radiation and temperature at or above room temperature. Due to the very low visible light reflectance, the adhesive is particularly applicable to optical products that demand minimal interference with visible light transmission.

### BACKGROUND

### Field

The present invention relates to adhesive materials generally, and more particularly to dual-cure, single-component compositions that exhibit strong adhesion properties subsequent to cure by electromagnetic radiation and thermal energy. Moreover, the present invention relates to dual-cure, single component adhesive compositions that exhibit low reflectance of visible light.

### Brief Description of Related Technology

Curable resin systems that cure with heat and electromagnetic radiation are known as dual-cure compositions. Typically, electromagnetic radiation bands useful in curing dual-cure compositions include infrared, visible, ultraviolet, and x-ray wavelengths, as well as corpuscular radiation such as electron beams. Visible and ultraviolet radiation wavelengths are most commonly used to cure dual-cure compositions.

Various dual-cure resin systems have been employed for coatings, adhesives, and sealing materials. Acrylate-based adhesives are well known, examples including a urethane (meth)acrylate containing free isocyanate groups and (meth)acryloyl groups, a photoinitiator and an isocyanate-reactive compound such as a polyol or polyamine. Some light-curing acrylate adhesives include isocyanate-containing resins having isocyanate groups cross-linked via amine clusters in a second curing mechanism. Another dual-cure resin system includes a photoinitiator, and epoxy resin, and a resin curable by a free radical. These resin systems, however, are typically deployed as multi-component applications, wherein the multiple components are maintained separately until dispensed for reaction in situ. Multi-component resin systems require special handling measures and dispensing equipment, which add to cost and complexity of the overall solution. A single-component resin system with dual-cure capability would significantly enhance the efficiency of adhesive delivery and cure.

The dual-cure property is used in adhesives to establish a fast initial attachment by light curing to prevent attached bodies from shifting during handling prior to final securement with a temperature cure. While this adhesive modality is preferred in many disparate applications, known dual-cure adhesives exhibit relatively high visible light reflectance properties, which limits utility in products sensitive to light reflectance. An example of such a product is an optical lens that requires adhesive bonding between adjacent lens barrels. Securement of optical equipment to respective fixtures may also demand low-reflectance adhesives.

It is therefore contemplated within the present invention to provide a single-component adhesive that is curable by electromagnetic radiation and thermal energy, and which exhibits low visible light reflectance subsequent to cure.

It is also contemplated within the present invention to provide a single-component, dual-cure adhesive that exhibits low visible light reflectance and good adhesion subsequent to cure.

### SUMMARY

By means of the present invention, low visible light reflectance is provided in a single-component, dual-cure adhesive. The adhesive may therefore be used in optically sensitive applications without disruption of optical performance. The adhesive composition includes a curable resin matrix having a polymer system that is deliverable in a single component and cross-linkable both by exposure to electromagnetic radiation and by heating to a cure temperature. The composition further includes a matting agent dispersed with the curable resin matrix, wherein the adhesive composition exhibits a visible light reflectance that is significantly reduced when in a cured condition.

In one embodiment, the dual-cure adhesive composition includes a curable resin matrix having one or more of an acrylate and an isocyanate polymer system or a hybrid resin system that contains both acrylate and isocyanate groups, an acrylate and an epoxy polymer system (or resin contain both acrylate and epoxy groups), and a bismaleimide and a vinyl ether polymer system, wherein the matrix is deliverable in a single component arrangement and curable both by exposure to electromagnetic radiation and by heating to a cure temperature (such as no greater than 80° C.). The composition further includes a matting agent dispersed with the curable resin matrix, wherein the adhesive composition exhibits a visible light reflectance that is significantly reduced (such as less than 5%) when in a cured condition.

The curable resin matrix includes between 20-90 percent by weight of curable resin, preferably with a blend of two or more curable resins. The matrix may more preferably include between 35-80 percent by weight of the curable resin composition.

The dual-cure adhesive composition includes between 1-25 percent by weight of one or more matting agents compatible with the resin matrix, and which are effective in reducing visible light reflectance. The composition may preferably include between 1-15 percent by weight of one or more matting agents.

In some embodiments, the matting agent may be selected from various materials, and is desirably selected from particulate materials such as silicas, waxes, organic fillers, metals and woods. The particulate matting agent has an average particle diameter (d₅₀) of 1-100 μm, preferably between 1-25 μm, and more preferably between 1-10 μm. The matting agent also has a surface area of at least 100 m²/g, and more preferably at least 150 m²/g.

The dual-cure adhesive composition may include a photoinitiator to aid in cure through exposure to electromagnetic radiation, such as in the ultraviolet-visible range of 250-750 nm. The composition preferably includes between 0.1-5 percent by weight of a photoinitiator capable of forming radicals when irradiated with light.

The dual-cure adhesive composition may include 0-40 percent by weight of additives selected from fillers, stabilizers, pigments, hardeners, dyes, thixotropic agents, thickeners, diluents, solvents, UV absorbers, light stabilizers, free-radical scavengers, crosslinking agents, wetting agents, dispersants, adhesion promoters, flame retardants, corrosion inhibitors, waxes, binders, and catalysts.

A method for bonding a first body to a second body includes applying a dual-cure adhesive composition in contact with the first and second bodies to form an adhesion layer. The adhesion layer is then exposed to electromagnetic radiation of a wavelength and duration effective to fix the first body to the second body as a fixture. Thereafter, the fixture is heated to a cure temperature (such as less than 80° C.), wherein the adhesive composition exhibits a visible light reflectance that is significantly reduced (such as less than 5%) when in a cured condition. The effective electromagnetic radiation wavelength may be between 250-750 nm, and more preferably between 250-500 nm.

At least one of the first and second bodies are transparent to electromagnetic radiation in the range of at least 400-750 nm, and, in some embodiments, at least between 250-750 nm. The fixture formed by the first body fixed to the second body may be an optical lens. In some embodiments, both of the first and second bodies adhered together with the dual-cure adhesive are transparent to electromagnetic radiation in the range of at least 400-750 nm, and in some embodiments at least between 250-750 nm.

### BRIEF DESCRIPTION OF THE DRAWINGS

FIG. 1 is a schematic illustration of a reflectance probe apparatus useful in measuring visible light reflectance of adhesive compositions of the present invention.

FIG. 2 is a schematic illustration of a portion of the reflectance probe apparatus illustrated in FIG. 1.

FIG. 3 is a schematic illustration of a portion of the reflectance probe apparatus illustrated in FIGS. 1 and 2.

### DETAILED DESCRIPTION

In accordance with the present invention, there is provided adhesive compositions comprising:

a curable resin matrix, including a polymer system that is curable both by exposure to electromagnetic radiation and by heating to a cure temperature; and

a matting agent dispersed with the curable resin matrix, wherein the adhesive composition exhibits a substantially reduced visible light reflectance when in a cured condition.

### Resin

A wide variety of resins may be usefully employed in the matrices of the present invention, limited by the system being curable both by exposure to electromagnetic radiation and by heating to a cure temperature, as well as exhibiting some preferred physical properties. The resin system of the present invention is preferably storable and deliverable as a single component, wherein the resin matrix may be dispensed from a single mass and thereafter cured. Multiple component resin systems, by contrast, require storage and delivery from separate masses to form the end product. Preferably, the composition should exhibit good adhesion properties upon each and both of electromagnetic radiation cure and thermal energy cure. As tested by ASTM D3359, the composition following cure by only electromagnetic radiation exposure exhibits adhesion of at least 25 psi, and more preferably at least 40 psi, and still more preferably at least 50 psi. The composition following cure by only thermal energy exposure exhibits adhesion of at least 100 psi, and more preferably at least 200 psi, and still more preferably at least 250 psi. The composition following cure by both electromagnetic radiation and thermal energy exposure exhibits adhesion of least 100 psi, and more preferably 200 psi, and still more preferably at least 300 psi.

The composition also exhibits relatively low bulk modulus following cure, so that the adhesive retains compliancy in bonding to adjacent surfaces. Post-curing bulk modulus of the composition is preferably less than 1 MPa at 20° C., and more preferably less than 500,000 Pa at 20° C., and still more preferably between about 20,000-400,000 Pa at 20° C.

Resin matrices of the present invention may also promote viscosity stability, wherein the cured composition exhibits less than 50% increase in steady-state viscosity over 48 hours from curing, and more preferably less than 40% increase in steady-state viscosity over 48 hours from curing, and still more preferably less than 25% increase in steady-state viscosity over 48 hours from curing.

Resin matrices employed herein are present in the range of about 10 up to about 95 percent by weight of the adhesive compositions; in some embodiments, the adhesive compositions comprise in the range of about 15 up to about 95 percent by weight resin matrix; in some embodiments, the adhesive compositions comprise in the range of about 20 up to about 95 percent by weight of resin matrix; in some embodiments, the adhesive compositions comprise in the range of about 25 up to about 95 percent by weight of resin matrix; in some embodiments, the adhesive compositions comprise in the range of about 35 up to about 95 percent by weight of resin matrix.

In some embodiments, resin matrices employed herein are present in the range of about 10 up to about 90 percent by weight of the adhesive compositions; in some embodiments, the adhesive compositions comprise in the range of about 15 up to about 90 percent by weight of resin matrix; in some embodiments, the adhesive compositions comprise in the range of about 20 up to about 90 percent by weight of resin matrix; in some embodiments, the adhesive compositions comprise in the range of about 25 up to about 90 percent by weight of resin matrix; in some embodiments, the adhesive compositions comprise in the range of about 35 up to about 90 percent by weight of resin matrix.

In some embodiments, resin matrices employed herein are present in the range of about 10 up to about 80 percent by weight of the adhesive compositions; in some embodiments, the adhesive compositions comprise in the range of about 15 up to about 80 percent by weight resin matrix; in some embodiments, the adhesive compositions comprise in the range of about 20 up to about 80 percent by weight of resin matrix; in some embodiments, the adhesive compositions comprise in the range of about 20 up to about 80 percent by weight of resin matrix; in some embodiments, the adhesive compositions comprise in the range of about 25 up to about 80 percent by weight of resin matrix; in some embodiments, the adhesive compositions comprise in the range of about 35 up to about 80 percent by weight of resin matrix.

Example resins suitable for the resin matrix of the present invention include resins with at least one isocyanate-reactive functional group, including at least one bond that may be activated with electromagnetic radiation. Example isocyanate-reactive functional groups include thiol groups, primary and secondary amino groups, and primary and secondary hydroxyl groups. The activateable bonds are present in, for example, (meth)acrylate, (eth)acrylate, vinyl ether, vinyl ester, ethenylarylene, dicyclopentadienyl, isoprenyl, isopropenyl, allyl or butenyl groups, dicyclopentadienyl ether, isporenyl ether, isopropenyl ether, allyl ether or butenyl ether groups, ethenylarylene ester, dicyclopentadienyl ester, isprenyl ester, isopropenyl ester, allyl ester or butenyl ester groups.

Acrylates contemplated for use in the present invention are well known in the art, as set forth in U.S. Pat. No. 5,717,034, the entire contents of which being incorporated herein by reference. Exemplary acrylates contemplated for use herein include monofunctional (meth)acrylates, difunctional (meth)acrylates, trifunctional (meth)acrylates, polyfunctional (meth)acrylates, and the like.

Exemplary monofunctional (meth)acrylates include phenylphenol acrylate, methoxypolyethylene acrylate, acryloyloxyethyl succinate, fatty acid acrylate, methacroloyloxyethylphthalic acid, phenoxyethylene glycol methacrylate, fatty acid methacrylate, β-carboxyethyl acrylate, isobornyl acrylate, isobutyl acrylate, t-butyl acrylate, hydroxyethyl acrylate, hydroxypropyl acrylate, dihydrocyclopentadiethyl acrylate, cyclohexyl methacrylate, t-butyl methacrylate, dimethylaminoethyl methacrylate, diethlylaminoethyl methacrylate, t-butylaminoethyl methacrylate, 4-hydroxybutyl acrylate, tetrahydrofurfuryl acrylate, benzyl acrylate, ehylcarbitol acrylate, phenoxyehtyl acrylate, methoxytriethlene glycol acrylate, monpentaerythritol acrylate, dipentaerythritol acrylate, tripentaerythritol acrylate, polypentaerythritol acrylate, and the like.

Exemplary difunctional (meth)acrylates include hexanediol dimethacrylate, hydroxyacryloyloxypropyl methacrylate, hexanediol diacrylate, urethane acrylate, epoxyacrylate, bisphenol A-type epoxyacrylate, modified epoxyacrylate, fatty acid-modified epoxyacrylate, amine-modified bisphenol A-type epoxyacrylate, allyl methacrylate, ethylene glycol dimethacrylate, diethylene glycol dimethacryrlate, ehoxylated bisphenol A dimethacrylate, tricyclodecanedimethanol dimethacrylate, glycerine dimethacrylage, polypropylene glycol diacrylate, propoxylated ethoylated bisphenol A diacrylate, 9,9 bis-(4-(2-acryloyloxyehoxy)phenyl) fluorine, tricyclodecane diacrylate, dipropyleneglycol diacrylate, polypropylene glycol diacrylate, PO-modified neopentyl glycol diacrylate, tricyclodecanedimethanol diacrylate, 1,12-dodecanediol dimethacrylate, and the like.

Exemplary trifunctional (meth)acrylates include trimethylolpropane trimethacrylate, trimethylolpropane triacrylate, trimethylolpropane epoxy triacrylate, polyether triacrylate, glycerine propoxy triacrylate, and the like.

Exemplary polyfunctional (meth)acrylates include dipentaerythritol polyacrylate, dipentaerythritol hexaacrylate, pentaerythritol tetraacrylate, pentaerythriolethoxy tetraacrylate, ditrimethololpropane tetraacrylate, and the like.

A polymer system with an acrylate may include an isocyanate, such as a polyisocyanate that typically contains at least 2 isocyanate groups per molecule. Example isocyanates include isocyanato-containing polyurethane prepolymers formed by reacting polyols with and excess of diisocyanates. Examples of suitable diisocyanates are isophorone diisocyanate (i.e., 5-isocyanato-1-iso-cyanatomethyl-1,3,3-trimethylcyclohexane), 5-iso-cyanato-1-(2-isocyanatoeth-1-yl)-1,3,3-trimethylcyclo-hexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-iso-cyanatoprop-1-yl)-cyclohexane, 1-isocyanato-2-(3-iso-cyanatoeth-1-yl)cyclohexane, 1-isocyanato-2-(4-iso-cyanatobut-1-yl)-cyclohexane, 1,2-diisocyanatocyclo-butane, 1,3-diisocyanatocyclobutane, 1,2-diisocyanato-cyclopentane, 1,3-diisocyanatocyclopentane, 1,2-diiso-cyanatocyclohexane, 1,3-diisocyanatocyclohexane, 1,4-diisocyanatocyclohexane, dicyclohexylmethane 2,4′-diisocyanate, trimethylene diisocyanate, tetramethylene diisocyanate, pentamethylene diisocyanate, hexa-methylene diisocyanate (HDI), ethylethylene diiso-cyanate, trimethylhexane diisocyanate, heptamethylene diisocyanate or diisocyanates derived from dimeric fatty acids, as sold under the commercial designation DDI 1410 from Henkel AG & Co. KGaA, Dusseldorf, Germany and described in International Patent Publication Nos. WO 97/49745 and WO 97/49747, especially 2-heptyl-3,4-bis(9-isocyanatononyl)-1-pentylcyclohexane, or 1,2-, 1,4- or 1,3-bis(isocyanatomethyl)cyclohexane, 1,2-, 1,4- or 1,3-bis(2-isocyanatoeth-1-yl)cyclohexane, 1,3-bis(3-isocyanatopropy-1-yl)cyclohexane, 1,2-, 1,4- or 1,3-bis(4-isocyanatobut-1-yl)cyclohexane or liquid bis(4-isocyanatocyclohexyl)methane with a trans/trans content of up to 30 percent by weight, preferably 25 percent by weight and in particular 20 percent by weight, as described in one or more of the following patent documents DE 44 14 032 A1, GB 1220717 A1, DE 16 18 795 A1 and DE 17 93 785 A1, preferably isophorone diisocyanate, 5-isocyanato-1-(2-iso-cyanatoeth-1-yl)-1,3,3-trimethylcyclohexane, 5-iso-cyanato-1-(3-isocyanatoprop-1-yl)-1,3,3-trimethylcyclo-hexane, 5-isocyanato-(4-isocyanatobut-1-yl)-1,3,3-tri-methylcyclohexane, 1-isocyanato-2-(3-isocyanatoprop-1-yl)cyclohexane, 1-isocyanato-2-(3-isocyanatoeth-1-yl)-cyclohexane, 1-isocyanato-2-(4-isocyanatobut-1-yl)-cyclohexane or HDI, especially HDI.

It is also possible to use polyisocyanates containing isocyanurate, biuret, allophanate, iminooxadiazinedione, urethane, urea, carbodiimide and/or uretdione groups, which are prepared in a customary and known manner from the diisocyanates described above.

Another example polymer system with an acrylate may include an epoxy resin, including aliphatic, cycloaliphatic, and aromatic epoxy resins and mixtures thereof. Examples of aliphatic epoxy resins include butanediol diglycidyl ether, hexanediol diglycidyl either, dimethylpentane dioxide, butadiene diocide, and diethyleneglycol diglycidyl ether. Example cycloaliphatic epoxy resins include 3-cyclohexenylmethyl-3-cyclohexyl carboxylate diepoxide, 3,4-epoxycyclohexylalkyl-3′,4′-epoxycyclohexane carboxylate, 3,4-epoxy methylcyclohexylmethyl-3′,4′-epoxy-6-methylcyclohexane carboxylate, vinylcyclohexane dioxide, bis(3,4-epoxycyclohexylmethyl) adipate, dicyclopentadiene dioxide, and 1,2-epoxy-6-(2,3-epoxypropoxy)hexahydro-4,7-methanindan. The use of 3,4-epoxycyclohexylmethyl-3′,4′-epoxycyclohexyl carboxylate is preferred.

Aromatic epoxy resins can also be used in the masses according to the present invention. Examples of aromatic epoxy resins are bisphenol-A epoxy resins, bisphenol-F epoxy resins, epoxy phenol novolac resins, epoxy cresol novolac resins, biphenyl epoxy resins, 4,4′-biphenyl epoxy resins, divinylbenzene dioxide, 2-glycidylphenylglycidyl ether.

A wide variety of epoxy-functionalized resins are contemplated for use herein, e.g., liquid-type epoxy resins based on bisphenol A, solid-type epoxy resins based on bisphenol A, liquid-type epoxy resins based on bisphenol F (e.g., Epiclon EXA-835LV), multifunctional epoxy resins based on phenol-novolac resin, dicyclopentadiene-type epoxy resins (e.g., Epiclon HP-7200L), naphthalene-type epoxy resins, and the like, as well as mixtures of any two or more thereof.

Exemplary epoxy-functionalized resins contemplated for use herein include the diepoxide of the cycloaliphatic alcohol, hydrogenated bisphenol A (commercially available as Epalloy 5000), a difunctional cycloaliphatic glycidyl ester of hexahydrophthallic anhydride (commercially available as Epalloy 5200), Epiclon EXA-835LV, Epiclon HP-7200L, and the like, as well as mixtures of any two or more thereof.

In certain embodiments, the epoxy component may include the combination of two or more different bisphenol based epoxies. These bisphenol based epoxies may be selected from bisphenol A, bisphenol F, or bisphenol S epoxies, or combinations thereof. In addition, two or more different bisphenol epoxies within the same type of resin (such as A, F or S) may be used.

Commercially available examples of the bisphenol epoxies contemplated for use herein include bisphenol-F-type epoxies (such as RE-404-S from Nippon Kayaku, Japan, and EPICLON 830 (RE1801), 830S (RE1815), 830A (RE1826) and 830W from Dai Nippon Ink & Chemicals, Inc., and RSL 1738 and YL-983U from Resolution) and bisphenol-A-type epoxies (such as YL-979 and 980 from Resolution).

The bisphenol epoxies available commercially from Dai Nippon and noted above are promoted as liquid undiluted epichlorohydrin-bisphenol F epoxies having much lower viscosities than conventional epoxies based on bisphenol A epoxies and have physical properties similar to liquid bisphenol A epoxies. Bisphenol F epoxy has lower viscosity than bisphenol A epoxies, all else being the same between the two types of epoxies, which affords a lower viscosity and thus a fast flow underfill sealant material. The EEW of these four bisphenol F epoxies is between 165 and 180. The viscosity at 25° C. is between 3,000 and 4,500 cps (except for RE1801 whose upper viscosity limit is 4,000 cps). The hydrolyzable chloride content is reported as 200 ppm for RE1815 and 830W, and that for RE1826 as 100 ppm.

The bisphenol epoxies available commercially from Resolution and noted above are promoted as low chloride containing liquid epoxies. The bisphenol A epoxies have a EEW (g/eq) of between 180 and 195 and a viscosity at 25° C. of between 100 and 250 cps. The total chloride content for YL-979 is reported as between 500 and 700 ppm, and that for YL-980 as between 100 and 300 ppm. The bisphenol F epoxies have a EEW (g/eq) of between 165 and 180 and a viscosity at 25° C. of between 30 and 60. The total chloride content for RSL-1738 is reported as between 500 and 700 ppm, and that for YL-983U as between 150 and 350 ppm.

In addition to the bisphenol epoxies, other epoxy compounds are contemplated for use as the epoxy component of invention formulations. For instance, cycloaliphatic epoxies, such as 3,4-epoxycyclohexylmethyl-3,4-epoxycyclohexylcarbonate, can be used. Also monofunctional, difunctional or multifunctional reactive diluents may be used to adjust the viscosity and/or lower the Tg of the resulting resin material. Exemplary reactive diluents include butyl glycidyl ether, cresyl glycidyl ether, polyethylene glycol glycidyl ether, polypropylene glycol glycidyl ether, and the like.

Epoxies suitable for use herein include polyglycidyl derivatives of phenolic compounds, such as those available commercially under the tradename EPON, such as EPON 828, EPON 1001, EPON 1009, and EPON 1031 from Resolution; DER 331, DER 332, DER 334, and DER 542 from Dow Chemical Co.; and BREN-S from Nippon Kayaku. Other suitable epoxies include polyepoxides prepared from polyols and the like and polyglycidyl derivatives of phenol-formaldehyde novolacs, the latter of such as DEN 431, DEN 438, and DEN 439 from Dow Chemical. Cresol analogs are also available commercially under the tradename ARALDITE, such as ARALDITE ECN 1235, ARALDITE ECN 1273, and ARALDITE ECN 1299 from Ciba Specialty Chemicals Corporation. SU-8 is a bisphenol-A-type epoxy novolac available from Resolution. Polyglycidyl adducts of amines, amino alcohols and polycarboxylic acids are also useful in this invention, commercially available resins of which include GLYAMINE 135, GLYAMINE 125, and GLYAMINE 115 from F.I.C. Corporation; ARALDITE MY-720, ARALDITE 0500, and ARALDITE 0510 from Ciba Specialty Chemicals and PGA-X and PGA-C from the Sherwin-Williams Co.

Appropriate monofunctional epoxy coreactant diluents for optional use herein include those that have a viscosity which is lower than that of the epoxy component, ordinarily, less than about 250 cps.

The monofunctional epoxy coreactant diluents should have an epoxy group with an alkyl group of about 6 to about 28 carbon atoms, examples of which include C₆₋₂₈ alkyl glycidyl ethers, C₆₋₂₈ fatty acid glycidyl esters, C₆₋₂₈ alkylphenol glycidyl ethers, and the like.

In some embodiments, the epoxy component employed herein is a silane modified epoxy, e.g., a composition of matter that includes:

(A) an epoxy component embraced by the following structure:

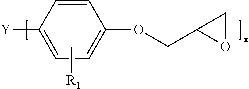

where:
Y may or may not be present and when Y present is a direct bond, CH₂, CH(CH₃)₂, C═O, or S,
R₁ here is alkyl, alkenyl, hydroxy, carboxy and halogen, and
x here is 1-4;
(B) an epoxy-functionalized alkoxy silane embraced by the following structure:

R¹—Si(OR²)₃

wherein
R¹ is an oxirane-containing moiety and
R² is an alkyl or alkoxy-substituted alkyl, aryl, or aralkyl group having from one to ten carbon atoms; and
(C) reaction products of components (A) and (B).

An example of one such silane-modified epoxy is formed as the reaction product of an aromatic epoxy, such as a bisphenol A, E, F or S epoxy or biphenyl epoxy, and epoxy silane where the epoxy silane is embraced by the following structure:

R¹—Si(OR²)₃

wherein
R¹ is an oxirane-containing moiety, examples of which include 2-(ethoxymethyl)oxirane, 2-(propoxymethyl)oxirane, 2-(methoxymethyl)oxirane, and 2-(3-methoxypropyl)oxirane and
R² is an alkyl or alkoxy-substituted alkyl, aryl, or aralkyl group having from one to ten carbon atoms.

In one embodiment, R¹ is 2-(ethoxymethyl)oxirane and R² is methyl.

Idealized structures of the aromatic epoxy used to prepare the silane modified epoxy include

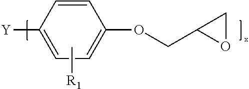

wherein:
Y may or may not be present, and when Y is present, it is a direct bond, CH₂, CH(CH₃)₂, C═O, or S,
R₁ is alkyl, alkenyl, hydroxy, carboxy or halogen, and
x is 1-4.

Of course, when x is 2-4, chain extended versions of the aromatic epoxy are also contemplated as being embraced by this structure.

For instance, a chain extended version of the aromatic epoxy may be embraced by the structure below

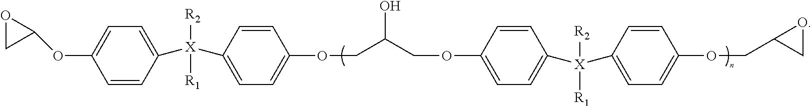

In some embodiments, the siloxane modified epoxy resin has the structure:

—(O—Si(Me)₂-O—Si(Me)(Z)—O—Si(Me)₂-O—Si(Me)₂)ₙ-

wherein:
Z is —O—(CH₂)₃—O-Ph-CH₂-Ph-O—(CH₂—CH(OH)—CH₂—O-Ph-CH₂-Ph-O—)ₙ—CH₂— oxirane, and n falls in the range of about 1-4.

In some embodiments, the siloxane modified epoxy resin is produced by contacting a combination of the following components under conditions suitable to promote the reaction thereof:

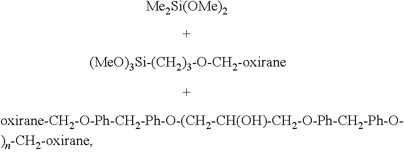

wherein “n” falls in the range of about 1-4.

The silane modified epoxy may also be a combination of the aromatic epoxy, the epoxy silane, and reaction products of the aromatic epoxy and the epoxy silane.

Epoxy cure agents are optionally employed in combination with epoxy monomer(s). Exemplary epoxy cure agents include ureas, aliphatic and aromatic amines, amine hardeners, polyamides, imidazoles, dicyandiamides, hydrazides, urea-amine hybrid curing systems, free radical initiators (e.g., peroxy esters, peroxy carbonates, hydroperoxides, alkylperoxides, arylperoxides, azo compounds, and the like), organic bases, transition metal catalysts, phenols, acid anhydrides, Lewis acids, Lewis bases, and the like.

Additional exemplary resins useful in the matrices of the present invention include maleimides, nadimides, itaconimides, cyanate esters, alkyd resins cyanate esters, phenolics, benzoxazines, polyimides, functionalized polyimides, oxetanes, vinyl ether, polyurethanes, melamines, urea-formaldehyde resins, phenol-formaldehyde resins, silicone, and the like, as well as mixtures of any two or more thereof.

Maleimides, nadimides or itaconimides contemplated for use herein are compounds having the structure:

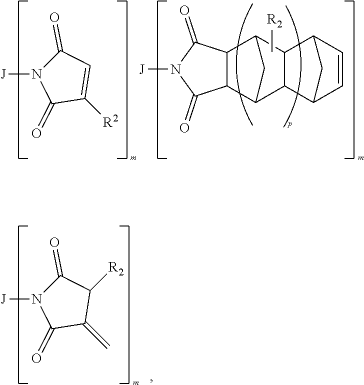

respectively, wherein:

m is 1-15,

p is 0-15,

each R² is independently selected from hydrogen or lower alkyl (such as C₁₋₅), and

J is a monovalent or a polyvalent radical comprising organic or organosiloxane radicals, and

combinations of two or more thereof.

In some embodiments of the present invention, J is a monovalent or polyvalent radical selected from:
hydrocarbyl or substituted hydrocarbyl species typically having in the range of about 6 up to about 500 carbon atoms, where the hydrocarbyl species is selected from alkyl, alkenyl, alkynyl, cycloalkyl, cycloalkenyl, aryl, alkylaryl, arylalkyl, aryalkenyl, alkenylaryl, arylalkynyl or alkynylaryl, provided, however, that X can be aryl only when X comprises a combination of two or more different species;
hydrocarbylene or substituted hydrocarbylene species typically having in the range of about 6 up to about 500 carbon atoms, where the hydrocarbylene species are selected from alkylene, alkenylene, alkynylene, cycloalkylene, cycloalkenylene, arylene, alkylarylene, arylalkylene, arylalkenylene, alkenylarylene, arylalkynylene or alkynylarylene,
heterocyclic or substituted heterocyclic species typically having in the range of about 6 up to about 500 carbon atoms,
polysiloxane, or
polysiloxane-polyurethane block copolymers, as well as combinations of one or more of the above with a linker selected from covalent bond, —O—, —S—, —NR—, —NR—C(O)—, —NR—C(O)—O—, —NR—C(O)—NR—, —S—C(O)—, —S—C(O)—O—, —S—C(O)—NR—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R₂—, —S—P(O)R₂—, or —NR—P(O)R₂—; where each R is independently hydrogen, alkyl or substituted alkyl.

Exemplary compositions include those wherein J is oxyalkyl, thioalkyl, aminoalkyl, carboxylalkyl, oxyalkenyl, thioalkenyl, aminoalkenyl, carboxyalkenyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkenylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl, oxyalkylene, thioalkylene, aminoalkylene, carboxyalkylene, oxyalkenylene, thioalkenylene, aminoalkenylene, carboxyalkenylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenylene, aminocycloalkenylene, carboxycycloalkenylene, oxyarylene, thioarylene, aminoarylene, carboxyarylene, oxyalkylarylene, thioalkylarylene, aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, aminoalkenylarylene, carboxyalkenylarylene, oxyarylalkynylene, thioarylalkynylene, aminoarylalkynylene, carboxy arylalkynylene, oxyalkynylarylene, thioalkynylarylene, aminoalkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, or a carboxyheteroatom-containing di- or polyvalent cyclic moiety.

Polyurethanes contemplated for use in the practice of the present invention refer to polymers composed of a chain of organic units joined by carbamate (urethane) links. Polyurethane polymers are formed by reacting an isocyanate with a polyol. Both the isocyanates and polyols used to make polyurethanes contain on average two or more functional groups per molecule.

Melamines contemplated for use in the practice of the present invention refer to hard, thermosetting plastic materials made from melamine (i.e., 1,3,5-triazine-2,4,6-triamine) and formaldehyde by polymerization. In its butylated form, it can be dissolved in n-butanol and/or xylene. It can be used to cross-link with other resins such as alkyd, epoxy, acrylic, and polyester resins.

Urea-formaldehydes contemplated for use in the practice of the present invention refers to a non-transparent thermosetting resin or plastic made from urea and formaldehyde heated in the presence of a mild base such as ammonia or pyridine.

Phenol-formaldehydes contemplated for use in the practice of the present invention refer to synthetic polymers obtained by the reaction of phenol or substituted phenol with formaldehyde.

### Matting Agent

The matting agent may generally be selected from silicas, waxes, organic fillers, metals and woods, as well as the metal salt and/or the metal complexes of organic compounds with such waxes. Natural or synthetic waxes such as polypropylene waxes, carnauba wax, shellac wax or paraffin are examples. The matting agent is preferably in particulate form, of amorphous shape, easily dispersible in the resin matrix, efficient in reducing visible light reflectance in the cured composition, has little influence on the rheological properties of the composition, and is chemically inert.

Various silica forms may be employed as matting agents in the present compositions. Untreated and surface-treated precipitated silica, and untreated and surface-treated fumed silica are examples, with the silica surface treatment typically grafting or otherwise modifying the surface with a wax or other polymer.

Matting agents used in the adhesive compositions of the present invention are present in the range of about 0.5 up to about 25 percent by weight; in some embodiments, the adhesive compositions comprise in the range of about 1 up to about 25 percent by weight matting agent; in some embodiments, the adhesive compositions comprise in the range of about 3 up to about 25 percent by weight matting agent; in some embodiments, the adhesive compositions comprise in the range of about 5 up to about 25 percent by weight matting agent.

In some embodiments, matting agents used in the adhesive compositions of the present invention are present in the range of about 0.5 up to about 15 percent by weight; in some embodiments, the adhesive compositions comprise in the range of about 1 up to about 15 percent by weight matting agent; in some embodiments, the adhesive compositions comprise in the range of about 3 up to about 15 percent by weight matting agent; in some embodiments, the adhesive compositions comprise in the range of about 5 up to about 15 percent by weight matting agent.

In some embodiments, matting agents used in the adhesive compositions of the present invention are present in the range of about 0.5 up to about 10 percent by weight; in some embodiments, the adhesive compositions comprise in the range of about 1 up to about 10 percent by weight matting agent; in some embodiments, the adhesive compositions comprise in the range of about 3 up to about 10 percent by weight matting agent; in some embodiments, the adhesive compositions comprise in the range of about 5 up to about 10 percent by weight matting agent.

Particulate matting agents used in the adhesive compositions of the present invention have an average particle size (d₅₀) in the range of about 0.1 to about 25 μm; in some embodiments, the average particle size is in the range of about 0.5 to about 25 μm; in some embodiments, the average particle size is in the range of about 1 to about 25 μm; in some embodiments, the average particle size is in the range of about 5 to about 25 μm.

In some embodiments, particulate matting agents used in the adhesive compositions of the present invention have an average particle size (d₅₀) in the range of about 0.1 to about 15 μm; in some embodiments, the average particle size is in the range of about 0.5 to about 15 μm; in some embodiments, the average particle size is in the range of about 1 to about 15 μm; in some embodiments, the average particle size is in the range of about 5 to about 25 μm.

Particulate matting agents used in the adhesive compositions of the present invention have an average particle size (d₅₀) in the range of about 0.1 to about 10 μm; in some embodiments, the average particle size is in the range of about 0.5 to about 10 μm; in some embodiments, the average particle size is in the range of about 1 to about 10 μm; in some embodiments, the average particle size is in the range of about 5 to about 10 μm.

Particulate matting agents used in the adhesive compositions of the present invention have a surface area of at least 50 m²/g. In some embodiments, the particulate matting agents have a surface area of at least 100 m²/g. In some embodiments, the particulate matting agents have a surface area of at least 150 m²/g. In some embodiments, the particulate matting agents have a surface area of at least 250 m²/g.

### Curing Agent

The dual-cure adhesive composition may include a curing agent (sometimes referred to herein as a thermal hardener) to aid in cross-linking of the resin matrices. In some embodiments, the curing agent may include a photoinitiator that is effective in facilitating the cure of electromagnetic radiation-curable resins. The photoinitiator may be capable of forming radicals when irradiated with light, such as within a range of between about 250-750 nm.

Example photoinitiators include α-hydroxyketone, benzophoenone, α,α-diethoxyacetophenone, 4,4-diethylaminobensophenone, 2,2-dimethoxy-2-phenylacetophenone, 4-isopropylphenyl-2-hydroxy-2-propylketone, 1-hydroxycyclohexylphenylketone, isoamyl-p-dimethlylaminobenzoate, methyl-4-dimethylaminobenzoate, methyl-o-benzoin isobutyl ether, 2-hydroxy-2-methyl-1-phenylpropane-1-on, 2-isopropylthixanthone, dibenzosuberone, 2,4,6-trimethylbenzoyldiphenylphonphine oxide, and bisacylphosphine oxide.

The dual-cure adhesive composition may include 0.01-10 percent by weight of a curing agent, such as a photoinitiator. In some embodiments, the adhesive composition includes between 0.1-5 percent by weight of a curing agent.

Curing with electromagnetic radiation may be accomplished through know radiation sources, examples of which are mercury vapor lames or electron beam sources. Curing with electromagnetic radiation may be accomplished in a single step, or may be phased over several dosage periods.

Thermal curing is typically accomplished with a heat source, such as an oven and/or an infrared lamp. Thermal curing is preferably effected at temperatures of not greater than 120° C., such as not greater than 100° C., desirably not greater than 80° C., so as to avoid damage to adjacent materials and equipment. Preferably, thermal curing is accomplished at or above room temperature for a period of between one minute and several hours.

Thermal curing agents, which are sometimes referred to as hardeners, include various amines and adducts thereof. Commercial examples of such hardeners include Ancamine-branded products from Evonik, the latent amine hardener EH series from Adeka, and Ajicure-branded products from Ajinomoto Fine-Techno. Thermal curing agents may be present in the dual-cure adhesive compositions at between 5-50 percent by and preferably between 5-25 percent by weight.

### Optional Additives

In accordance with some embodiments of the present invention, the compositions described herein may further comprise one or more additives selected from fillers, stabilizers, pigments, hardeners, dyes, thixotropic agents, thickeners, diluents, solvents, UV absorbers, light stabilizers, free-radical scavengers, crosslinking agents, wetting agents, dispersants, adhesion promoters, flame retardants, corrosion inhibitors, waxes, binders, and catalysts.

Example fillers include powders, silicates, ceramic particles, metal particles, metal oxide particles, glass particles, and the like.

Stabilizers may serve to increase storage stability and to protect the cured composition from degradation by heat or UV radiation.

Adhesion promoters include compounds which enhance the adhesive properties of the compositions to which they are introduced.

### Reflectance

The cured adhesive compositions of the present invention exhibit low visible light reflectance so as to minimize interference in the optical properties of a product using the adhesive. For the purposes hereof, the term “visible light” refers to electromagnetic radiation in the range of between about 350-800 nm, and preferably in the range of between 400-750 nm. In some embodiments, the cured adhesive composition exhibits a visible light reflectance of less than 8%. In some embodiments, the cured adhesive composition exhibits a visible light reflectance of less than 5%. In some embodiments, the cured adhesive composition exhibits a visible light reflectance of less than 3%. In some embodiments, the cured adhesive composition exhibits a visible light reflectance of less than 2%.

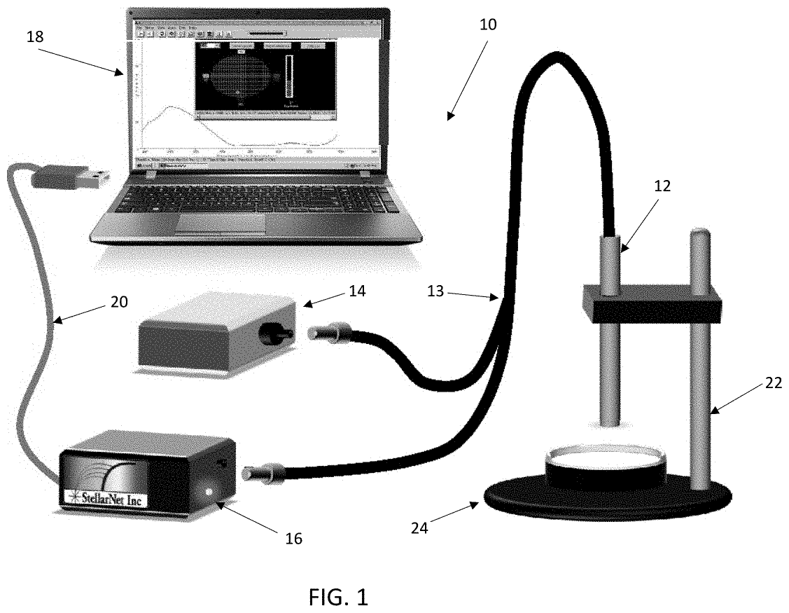

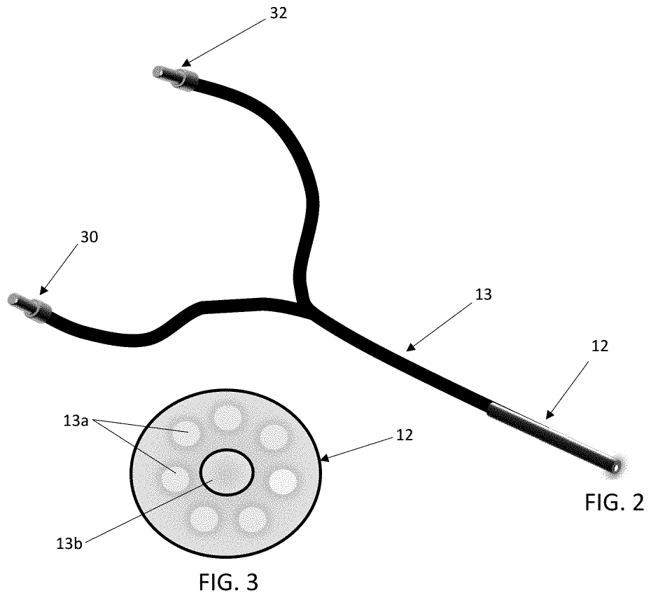

For the purposes hereof, the term “reflectance” is measured by the proportion of reflected visible light to incident visible light, with the incident visible light emitted perpendicularly (90°) to the tested substrate, and the reflected visible light being detected perpendicularly (90°) to the tested substrate. An example reflectance measurement apparatus is illustrated in FIGS. 1-3. A reflectance probe apparatus 10 is used to test reflectance of cured adhesive compositions adhered to a transparent glass or polymer body. Apparatus 10 includes a reflectance probe 12 linked by optical fibers 13 to a light source 14 and a spectrometer 16. Optical fibers 13 include an illumination port 30 to receive light from light source 14, and a read port 32 to deliver reflected light to spectrometer 16. Data output from spectrometer 16 can be delivered to a computer 18 through a data transmission cable 20. Reflectance probe 12 emits light in specified wavelength ranges to encounter the sample. Incident light reflected by the sample may be received by reflectance probe 12 and transmitted to spectrometer 16 through optical fibers 13 and read port 32.

Incident light to the sample may be emitted from probe 12 perpendicularly to the sample and from a distance of between 0.25-2.5 cm, and more preferably between 0.5-2.0 cm. A probe holder stand 22 positions probe 12 for 90° angle reflectance measurements, wherein incident and measured reflected light is perpendicular to the sample. In some embodiments, a white reflectance standard 24 may be used to take reference measurements using reflector probe 12. White reflectance standard 24 may reflect greater than 97% of incident light between 300-1700 nm.

An example reflectance probe apparatus 10 is available from StellarNet, Inc., using an R600 reflectance probe with 7 illuminating fibers 13a wrapped around 1 central read fiber 13b. The central fiber 13b in this system is 600 μm core, while the illuminating fibers 13a are 400 μm core. The R600 probe is effective in emitting visible wavelength light, at least between 350-800 nm. The R600 probe may be mounted to an RPH1 probe holder for perpendicular measurements, and may emit light generated by an SL1 tungsten halogen light source having a wide spectral range of 350-2500 nm. A Black Comet concave grating spectrometer may be used for measurements in the range of between 190-900 nm.

The adhesive composition of the present invention may be used to bond a first body to a second body. Application of the dual-cure adhesive may be accomplished by any customary method, such as needle dispensing, spraying, dip coating, knife coating, brushing, and the like. Example spray applications include compressed air spraying, airless spraying, and electrostatic spray techniques. First and second bodies may be of any suitable material not damaged by the application or curing of the dual-cure adhesive composition. Example materials include glass, metals, plastics, and ceramics. In some embodiments, at least one of first and second bodies may be transparent to visible light. One or more of the bonded surfaces of first and second bodies may be pre-treated to facilitate a desired physical property. Example pre-treatments include priming, plasma treatment, and flame treatment. For the adhesive bonding, the dual-cure composition is applied to at least one surface of the first and second bodies to form an adhesion layer, and thereafter contacting the other body to the adhesion layer, under pressure if appropriate. In other embodiments, the dual-cure composition is applied to a gap between the first and second bodies for contemporaneous contact by the dual-cure composition to surfaces of the first and second bodies. The resulting adhesion layer is cured by exposure to electromagnetic radiation to fix the first body to the second body as a fixture, and by heating the fixture to a cure temperature. In some embodiments, the cure temperature is at or above room temperature, but is less than 80° C. In some embodiments, the cure temperature is at or above room temperature, but is less than 50° C. In some embodiments, the cure temperature is at or above room temperature, but is less than 40° C.

The adhesion layer is preferably of a thickness that is necessary and useful for its functions. In some embodiments, the adhesion layer is between 1-1000 μm in thickness. In some embodiments, the adhesion layer is between 20-100 μm in thickness. In some embodiments, the adhesion layer is between 25-80 μm in thickness. The adhesion layer is preferably tacky, in order to effectuate a desired extent of adhesion between bodies.

The dual-cure adhesive composition is cured through exposure to electromagnetic radiation. In some embodiments, the dual-cure adhesive composition is cured through exposure to ultraviolet radiation, such as in the range of between 250-400 nm. Examples of suitable radiation sources include high or low pressure mercury vapor lamps or electron beam sources. The dual-cure adhesive composition is also cured through exposure to thermal energy. In some embodiments, the dual-cure adhesive composition is cured at temperatures at or above room temperature, and may be less than 80° C. The thermal energy may, for example, be applied to the dual-cure adhesive composition with an oven or with infrared lamps.

### EXAMPLE

Dual-Cure, single-component adhesive compositions were prepared in accordance with the following formulations:

| Material | Concentration (wt %) |
|---|---|
| Acrylate/Isocyanate hybrid resin | 20-80 |
| Acrylate resin | 2-40 |
| Stabilizer | 0.1-2 |
| Photoinitiator | 0.1-5 |
| Hardener | 5-25 |
| Matting Agent | 1-25 |
| Carbon Black | 0.01-4 |

The acrylate/isocyanate hybrid resin used was a low-viscous isocyanate-functional unsaturated acrylic ester resin, based on allophanated hexamethylene diisocyanate, available from BASF under the trade name Laromer® LR 9000. Alternative hybrid resins include isocyanate-bearing urethane acrylate monomers available from Allnex Netherlands under the trade names Ebecryl® 4150, Ebecryl® 4250, Ebecryl® 4396, and Ebecryl® 4397.

The acrylate resin used was a long-chain hydrophilic macromonomer of polyethylene glycol monomethacrylate having a PEG block molecular weight of 200 g/mol. Alternative acrylate resins include a combination methacrylate acid ester and 2-(2-ethoxyethoxy)ethyl acrylate available from Sartomer Americas under the trade name SR9050, and alkoxylated cyclohexane dimethanol diacrylate available from Sartomer Americas under the trade name CD581.

The stabilizer used was a p-toluenesulfonyl isocyanate for moisture scavenging.

The photoinitiator used was diphenyl(2,4,6-trimethylbenzoyl)phosphine oxide, as a monoacylphosphine oxide based photoinitiator.

The hardener used was a modified aliphatic polyamine curing agent available from Evonik under the trade name Ancamine® 2014FG.

The matting agent used was a polymer surface-modified thermal silica with an average particle size of 7.5 μm.

The formulation was blended in a high-speed hand mixer and dispensed on a polycarbonate substrate through a needle dispenser. A second substrate was contacted against the deposited adhesive and the adhesion layer of the fixture exposed to UV radiation at 365 nm with an intensity of 600 mW/cm² for 5 seconds. Adhesion of the UV-cured adhesion layer was tested at 40 psi by ASTM D3359. The bonded fixture was then heated to a cure temperature of 80° C. for 1 hour. Adhesion of the heat and UV-cured adhesion layer was tested at greater than 280 psi by ASTM D3359.

Reflectance of the cured adhesion layer was tested through the procedure described above, and measured at less than 5%.

1. An adhesive composition, comprising:
(i) 20-90 percent by weight of a curable resin matrix including a polymer system that is curable both by exposure to electromagnetic radiation and by heating to a cure temperature;
(ii) 1-25 percent by weight of a particulate matting agent dispersed with the curable resin matrix, wherein the adhesive composition exhibits a visible light reflectance of less than 5%, an adhesion of at least 100 psi; and
(iii) 0.1-5 percent by weight of a photoinitiator capable of forming radicals.

2. The adhesive composition of claim 1, further comprising 5-50 percent by weight of a thermal curing agent capable of curing the resin matrix by heat.

3. The adhesive composition of claim 1, wherein the cure temperature is no greater than 80° C.

4. The adhesive composition of claim 1, wherein the particulate matting agent includes one or more of silica, wax, metal, wood, and plastic.

5. The adhesive composition of claim 4, wherein the silica is surface modified with a polymer.

6. The adhesive composition of claim 4, wherein the particulate matting agent is in amorphous shape.

7. The adhesive composition of claim 1, wherein the particulate matting agent is present in the range of 5-10 percent by weight of the composition.

8. The adhesive composition of claim 1, wherein the particulate matting agent has an average particle size of between 1-25 μm.

9. The adhesive composition of claim 1, wherein the particulate matting agent has an average particle size of between 1-10 μm.

10. The adhesive composition of claim 7, wherein the particulate matting agent has a surface area of at least 100 m²/g.

11. The adhesive composition of claim 1, exhibiting a visible light reflectance of less than 2% when in a cured condition.

12. The adhesive composition of claim 1, wherein the curable resin matrix includes one or more of an acrylate and an isocyanate polymer system, a hybrid resin system with acrylate and isocyanate groups, an acrylate and an epoxy polymer system, a hybrid resin system with acrylate and epoxy groups, and a bismaleimide and a vinyl ether polymer system.

13. A method for bonding a first body to a second body, said method comprising:
(a) contacting the first and second bodies with the adhesive composition of claim 1 to form an adhesion layer intermediate of the first and second bodies;
(b) exposing the adhesion layer to electromagnetic radiation to fix the first body to the second body as a fixture; and
(c) subsequent to step (b), heating the fixture to a cure temperature.

14. The method as in claim 13, wherein the cure temperature is no greater than 80° C.

15. The method as in claim 13, wherein the electromagnetic radiation is between 250-400 nm.

16. The method as in claim 13, wherein at least one of the first and second bodies is transparent to light.

17. The method as in claim 16, wherein the fixture is an optical lens.

18. The method as in claim 13, wherein the adhesive composition exhibits an initial viscosity at 20° C. that increases by less than 25% over 72 hours.

19. The method as in claim 13, wherein the adhesion layer in a cured condition exhibits a visible light reflectance of less than 2%.

20. A camera module, comprising:
an optical lens that is transparent to electromagnetic radiation in the range of between about 400 nm to about 750 nm adhered to a lens barrel with the adhesive composition of claim 1.

21. The composition of claim 1, in a one part configuration.
